(19) United States
(12) Patent Application Publication
(10) Pub. No.: US 2008/0013555 A1
(43) Pub. Date: Jan. 17, 2008

(54) RECEIVING SYSTEM OR TERMINAL FOR CONTENTS VIA IP NETWORK

(76) Inventors: Hideki Kamimaki, Fujisawa (JP); Hiroki Miyamoto, Fujisawa (JP); Masato Suzuki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/776,594

(22) Filed: Jul. 12, 2007

(30) Foreign Application Priority Data
Jul. 14, 2006 (JP) 2006-193550

(51) Int. Cl. H04L 12/28

(52) U.S. Cl. 370/401

(57) ABSTRACT

A system that allows contents to be viewed suitably and allows channels to be switched promptly in a multi channel IP broadcast via multicast delivery using a broadband network, the system including: a home gateway device connected to a network and capable of receiving a stream, in which a plurality of contents are multiplexed, from the network; and an IP broadcast receiving terminal connected to the home gateway device. The receiving terminal transmits channel information corresponding to a desired content to the home gateway device. The home gateway device extracts, among the multiplexed contents in a received stream, a content corresponding to the channel information from the receiving terminal and supplies the same to the receiving terminal.

### INCORPORATION BY REFERENCE

The present application claims priority from Japanese application JP2006-193550 filed on Jul. 14, 2006, the content of which is hereby incorporated by reference into this application.

### BACKGROUND OF THE INVENTION

The technical field of the present invention relates to, for example, IP (Internet protocol) broadcast receiving systems and IP broadcast receiving terminal devices for receiving video contents via a broadband network.

Due to digitization of broadcast wave and progress in broadband, services to deliver video contents, such as high bit-rate high definition video, to each home via a network (e.g., FTTH: Fiber To The Home) is starting. Such service is carried out by delivering video contents to a plurality of receiving terminals by multicast delivery as described in JP-A-2005-86222, for example.

### SUMMARY OF THE INVENTION

Incidentally, in the broadband Internet, the increasing popularity of PON (Passive Optical Network) with a throughput of 2.4 Gbps allows for the transmission of, for example, 100 channels of streams of high definition processed by MPEG-2, for example. Then, the transmission technique and IP-network multicast technique allow for the delivery of 100 channels of streaming contents.

In the case where a stream of contents in which a plurality of channels are multiplexed is delivered via broadband network using IP multicast, if a large number of viewers simultaneously made a connection request for acquiring a desired content to a server that delivers the content, the transfer rate of the stream from the server may decrease due to a sudden increase in the traffic, so that the desired content may not be satisfactorily acquired. Such issue is not contemplated in JP-A-2005-86222.

Moreover, when channels are switched in the stream described above, “leave” and “join” processings need to be carried out to the contents distribution server each time channels are switched, and thus it is difficult to switch to a desired channel promptly.

One object of the present invention is to provide a technique capable of satisfactorily acquiring the content of a desired channel in a system that delivers contents via broadband network using IP multicast.

Moreover, another object of the present invention is to provide a technique capable of switching channels promptly in such system.

In order to achieve the above-described objects, this system includes a home gateway device capable of receiving from a network a stream in which a plurality of contents are multiplexed, for example. Then, the channel information corresponding to a desired content is transmitted to the home gateway device from a receiving terminal, such as a television set, for example, and the home gateway device extracts a content corresponding to the channel information from the receiving terminal among the multiplexed contents contained in a received stream and supplies this to the receiving terminal.

The above-described receiving terminal is capable of displaying a menu screen for selecting a desired content, the menu screen including a plurality of items, and it may be configured such that from this menu screen an item corresponding to a desired content is selected by an input section. Then, a network control section may transmit to the home gateway device the channel information of a content corresponding to the selected item and the channel information of a content corresponding to an item adjacent to the selected item.

The mounting of the home gateway function in the network control section in the above-described receiving terminal also allows for a system configuration without the home gateway device.

According to the above-described configuration, the content of a desired channel can be satisfactorily acquired in a system that delivers contents via broadband network using IP multicast, for example. Moreover, channels can be switched promptly in such system.

Other objects, features and advantages of the invention will become apparent from the following description of the embodiments of the invention taken in conjunction with the accompanying drawings.

### BRIEF DESCRIPTION OF THE DRAWINGS

FIG. 1 is a view showing an example of an IP broadcasting system.

FIG. 2 is a view showing an example of an IP broadcast receiving system in a home.

FIG. 3 is a configuration example of the software of an IP receiving terminal device.

FIG. 4 is a configuration example of the hardware of the IP receiving terminal device.

FIG. 5 is a view showing an example of a user action database stored in HDD 410.

FIG. 6 is a view showing another example of the database.

FIG. 7 is a flowchart showing an example of IP broadcast reception processing.

FIG. 8 is a view showing an example of a menu screen.

FIG. 9 is a view showing another example of the menu screen.

### DESCRIPTION OF THE EMBODIMENTS

Hereinafter, an example (embodiment) of a form suitable for implementation of the present invention will be described with reference to the accompanying drawings.

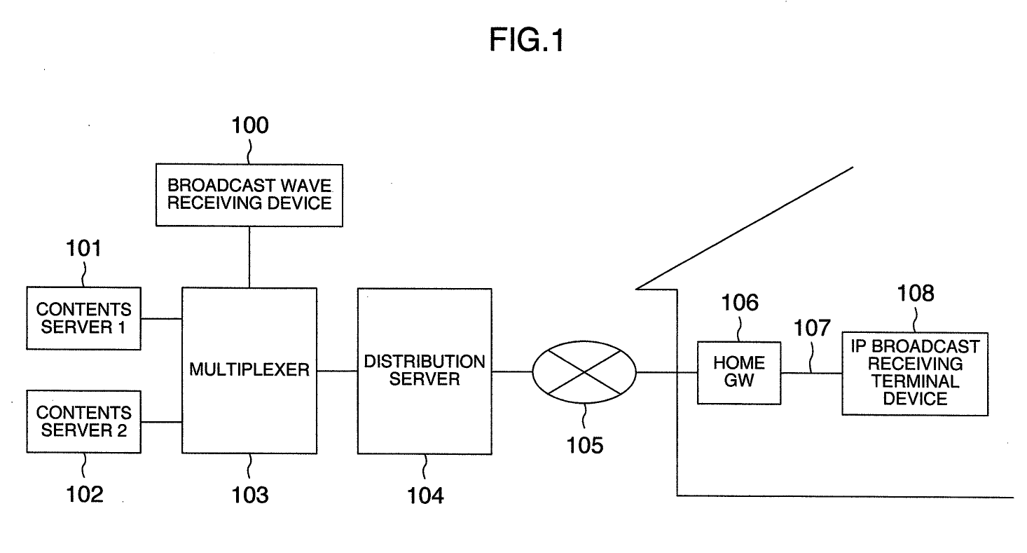

First, an example of an IP broadcasting system to which this embodiment can be applied is described with reference to FIG. 1. In FIG. 1, a broadcast wave receiving device 100 receives television broadcasting signals of ground-based digital broadcasting, BS/CS digital broadcasting, analog broadcasting, or the like, and transmits them to a multiplexing device 103. Moreover, a first contents server 101 and a second contents server 102 respectively transmit a transport stream (hereinafter, referred to as TS) of content, such as video, to the multiplexing device 103. The multiplexing device 103 multiplexes the television broadcasting signals from the broadcast wave receiving device 100, the streams of contents from the first and second contents servers, metadata such as program information, and various service information such as the format types of the content. A distribution server 104 turns a stream of the contents multiplexed in the multiplexing device 103, into an IP, and delivers this to a broadband network comprised of a network 105, such as FTTH, for example. Moreover, the distribution server 104 may be configured so as to manage the accounting information on pay contents and the user information such as a view history. These constitute the system configuration at the transmission side. Moreover, the video data is not limited to TS, but may be a programming stream (PS) handled in a download service, PC, or the like, and also the protocol thereof is not limited to a standard protocol.

On the other hand, a receiving side system installed at the receiving side, i.e., in a home, includes a home gateway device 106 connected to the Internet 105, and an IP broadcast receiving terminal device 108, such as a television set or a hard disk recorder, for example. Then, the home gateway device 106 and the IP broadcast receiving terminal device 108 are connected to each other via a home network 107 in a home.

The IP broadcast receiving terminal device 108 includes a remote controller, for example, and transmits in response to the operation to this remote controller an acquisition request of content which a user desires (namely, a user desires to view). This content acquisition request includes, for example, the channel information which a user desires, and is transmitted to the home gateway device 106 via the home network 107. On the other hand, the home gateway device 106 includes a dial-up router, for example, and receives a stream of multiplexed contents from the distribution server 104 via the network 105. Then, the home gateway device 106 extracts, among a received stream of multiplexed contents, the content of a channel corresponding to the content acquisition request transmitted from the IP broadcast receiving terminal device 108, and provides this to the IP broadcast receiving terminal device 08 via the home network 107. Thereby, the IP broadcast receiving terminal device 108 can acquire the content corresponding to a channel, which a user desires, and display or store the same.

With such a configuration, in this embodiment, IP rebroadcast that carries out redelivery of broadcast wave, and IP broadcast for supporting multicast that delivers to non-specific users can be accomplished using a broadband network comprised of such broadband network 105. Moreover, in this embodiment, it is also possible to enjoy services via the network 105, such as VOD (Video On Demand) that re-delivers the content upon a request from a user, voice calls, a triple play via the Internet access, and background recording of download content using the broadband.

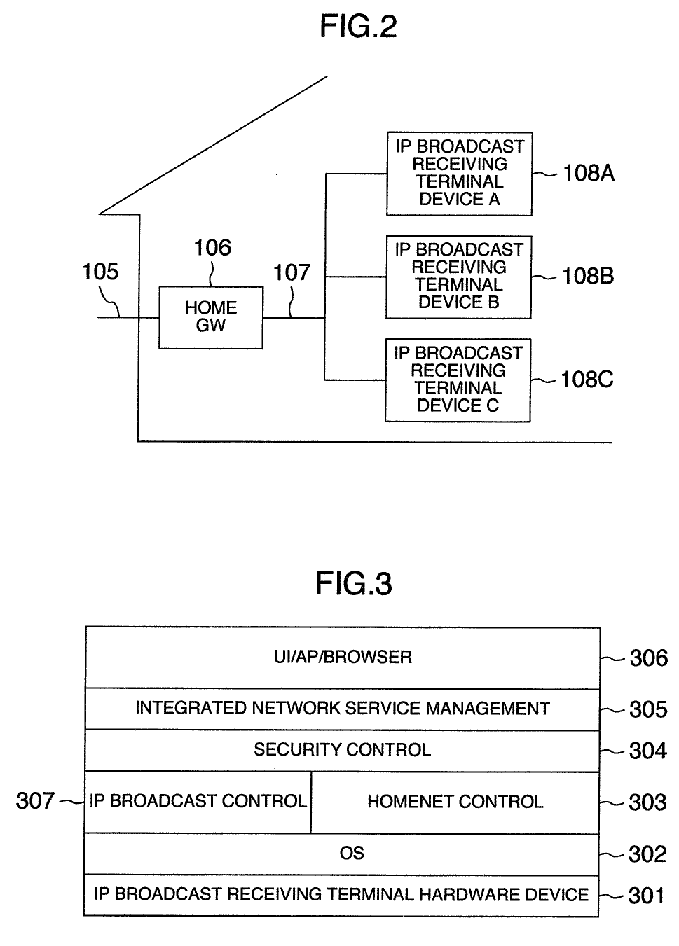

Next, an example of a system installed in a home is described with reference to FIG. 2. In the example of FIG. 2, assume that in a home there are installed three IP broadcast receiving terminals of IP broadcast receiving terminal A 108A to IP broadcast receiving terminal C 108C as IP broadcast receiving terminal 108. Here, for example, a case is described, where the IP broadcast receiving terminal device A 108A is a television set in a living room, the IP broadcast receiving terminal device B 108B is a hard disk recorder, and the IP broadcast receiving terminal device C 108C is a television set in a bedroom. In addition, for the IP broadcast receiving terminals A to C, a STB (set top box), a DVD player/recorder, a network media player, and the like may be used other than a television set and a hard disk recorder. Moreover, the television set may be the one in which HDD for storing contents is built in.

In the system shown in FIG. 2, the IP broadcast receiving terminal A 108A to IP broadcast receiving terminal C 108C each transmit a desired channel information and control information to the home gateway device 106 via the home network 107. Here, the control information transmitted from the IP broadcast receiving terminal A 108A to the IP broadcast receiving terminal C 108C shall include information indicative of the type of a request for viewing or storing a desired content. The home gateway device 106 delivers, among a stream of contents received from the network 105, a content corresponding to the channel information from each IP broadcast receiving terminal, to each IP broadcast receiving terminal. Here, for example, if the IP broadcast receiving terminal A 108A transmitted a channel number 3 as the channel information and a view request for the content as the control information, the home gateway device 106 provides a content corresponding to the channel number 3 to the IP broadcast receiving terminal A 108A. Moreover, if the IP broadcast receiving terminal C 108C transmitted a channel number 15 as the channel information and a store request of the content as the control information, the home gateway device 106 stores a content corresponding to the channel number 15 in an HDD device provided therein. Then, if the IP broadcast receiving terminal C 108C transmitted a reproduction request as the control information, the home gateway device 106 may reproduce the content of the channel number 15 stored in the HDD device in the home gateway device 106 and provide the same to the IP broadcast receiving terminal C 108C.

Here, via PON (Passive Optical Network) that is configured using a high-speed optical fiber as described above and has a throughput of 2.4 Gbps, the network 105 can transmit, for example, 100 channels of streams of high vision processed by MPEG-2 of a transfer rate of 24 Mbps. With this transmission technique and the multicast technique of the IP network, the above-described 100 channels of streaming contents can be delivered to each home in a region. More channels may be accommodated according to the technical progress in the band of the network 105, and the number of channels may vary depending on the form of service provision. Moreover, with such a system, it is possible to deliver to a large number of users the content which each user demanded. However, if a large number of users simultaneously carry out a connection request (access) for acquiring content with respect to the different contents via unicast, individually, the traffic may increase suddenly and thus the transfer rate of the content stream transmitted from the distribution server 104 may decrease significantly. Moreover, a fluctuation in the band in the stream transmission occurs depending on the number of accesses from users. In order to address this fluctuation, it is necessary to use the expensive distribution server 104, leading to an increase in the cost. Moreover, if information on a channel is transmitted to the distribution server 104 from the IP broadcast receiving terminal A 108A each time a user carries out a channel switching operation, a problem of decreasing the response speed of the channel switching also occurs, and thus a decrease in the user operability and in the response of the operation of the remote controller becomes an issue.

In order to prevent this, in this embodiment, the home gateway device 106 is placed in each home, and this home gateway device 106 receives all the stream of 100 channels of contents described above. Moreover, in this embodiment, one or more IP broadcast receiving terminals 108 provided in a home are connected to the home gateway device 106. Then, only the content of a channel, which each IP broadcast receiving terminal requested, among the 100 channels of contents which the home gateway device 106 received, is delivered to each IP broadcast receiving terminal based on the channel information from each IP broadcast receiving terminal. In other words, in this embodiment, from the network 105 to the home gateway device 106 in a home, 100 channels of contents are always delivered, while from the home gateway device 106 to each IP broadcast receiving terminal device, the content of a channel, which each IP broadcast receiving terminal device requests, among 100 channels of content, is delivered.

Accordingly, in this embodiment, it is possible to view/record the content of a channel, which a user desires, from a stream of multiplexed contents depending on the content of a service contract of a user, while preventing a decrease in the transfer rate of streams delivered from the distribution server 104.

Next, an example of the software configuration of the IP broadcast receiving terminal device 108 concerning this embodiment is described with reference to FIG. 3. The IP broadcast receiving hardware 301 incorporates an OS (operating system) 302 therein, and with this OS 302 the basic operation is executed. On this OS 302, communication is carried out by a streaming protocol and a standard protocol, whereby an IP broadcast control 307 that carries out the selection of a time stamp information and a content which a user desired, the IP broadcast control 307 distinguishing whether it is a pay content or not, and a network control 303 represented by DLNA (Digital Living Network Alliance) for sharing and viewing the content in a home operate. Moreover, the software concerning this embodiment includes: a software for a security control 304 for a security function for preventing an unauthorized entry from the network 105 and for copyright protection of a digital content; and a software for integrated network service management 305 for centralizing the services of the home network 107 in a home and the network 105 in the IP broadcast receiving terminal device 108 and for viewing a desired content in response to an operation from the remote controller. Moreover, the software also includes a user interface (UI) of the IP broadcast receiving terminal device, application (AP), and a browser 306 for Internet information acquisition. Because this embodiment includes the IP broadcast control 307 in this manner, it is possible to select and view a desired content from the network 105 via the IP broadcast receiving terminal hardware 301. The integrated network service management 305 in conjunction with conventional broadcast wave service allows a user to enjoy viewing video regardless of broadcast wave reception or broadband reception.

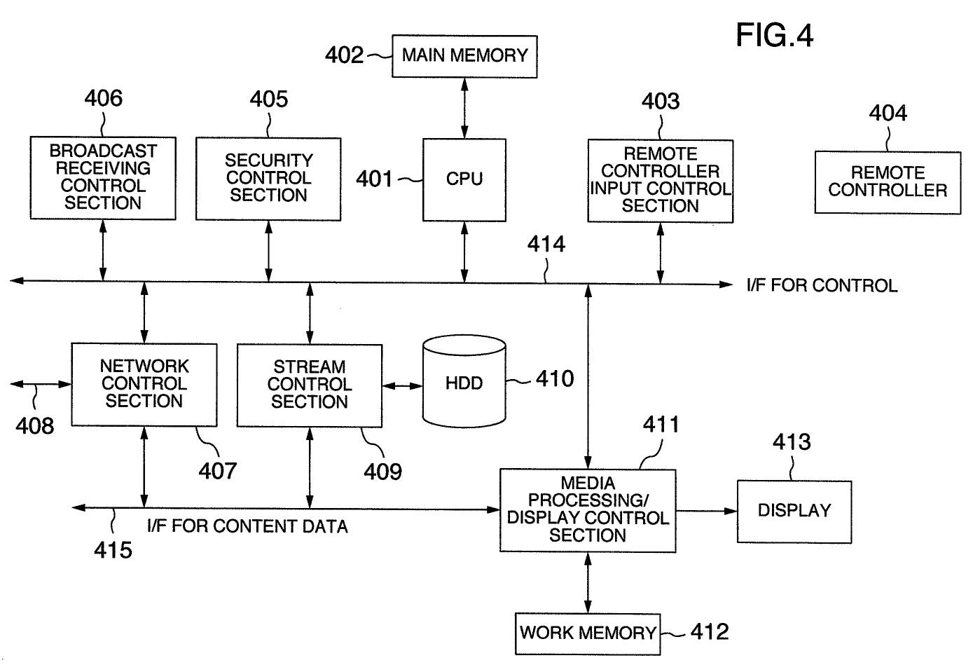

FIG. 4 shows an example of the hardware configuration of the IP broadcast receiving terminal device concerning this embodiment. In this example, as the IP broadcast receiving terminal device, a television set is described as an example. First, a case to receive regular television broadcast is described. A user operates the remote controller 404 to select a desired channel. The remote controller 404 outputs a remote control signal for tuning in this channel. A remote-controller input control section 403 receives the remote control signal from the remote controller 404 and outputs a channel switching signal for switching to the desired channel. This channel switching signal is provided to a broadcast reception control section 406 via an I/F for control. The broadcast reception control section 406 includes a tuner, for example, and carries out channel selection operation based on the channel switching signal from the remote-controller input control section 403 to receive television broadcasting signals (terrestrial analog/digital broadcasting signals, BS/CS analog/digital broadcasting signals) of the desired channel. Here, assume that the broadcast reception control section 406 receives a digital broadcasting signal encoded by MPEG-2 or the like and outputs a transport stream (TS) thereof. This TS is provided to a media processing/display control section 411 via an I/F 415 for content data. The media processing/display control section 411 contains an MPEG decoder, for example, and decodes the TS from the broadcast reception control section 406 to generate a video signal while using a work memory 412. Moreover, the media processing/display control section 411 carries out a predetermined signal processing to the decoded signal and provides this to a display 413. The display 413 displays the video based on the video signal from the media processing/display control section 411. In addition, the MPEG decoder may be contained in the broadcast reception control section 406 so that the decoded video signal instead of TS may be outputted from the broadcast reception control section 406, and it is also possible to accommodate a new coding scheme, such as H.264, which will be the mainstream in the future. Moreover, a security control section 405 manages the contract channels directed for pay service, accounting information, copyright protection information, and the like, and carries out authentication processing, decryption processing of encryption, and the like concerning the digital broadcast of a desired channel, in need of the contract state of a user and the like. This allows for provision of content securely without a content holder being illegally copied.

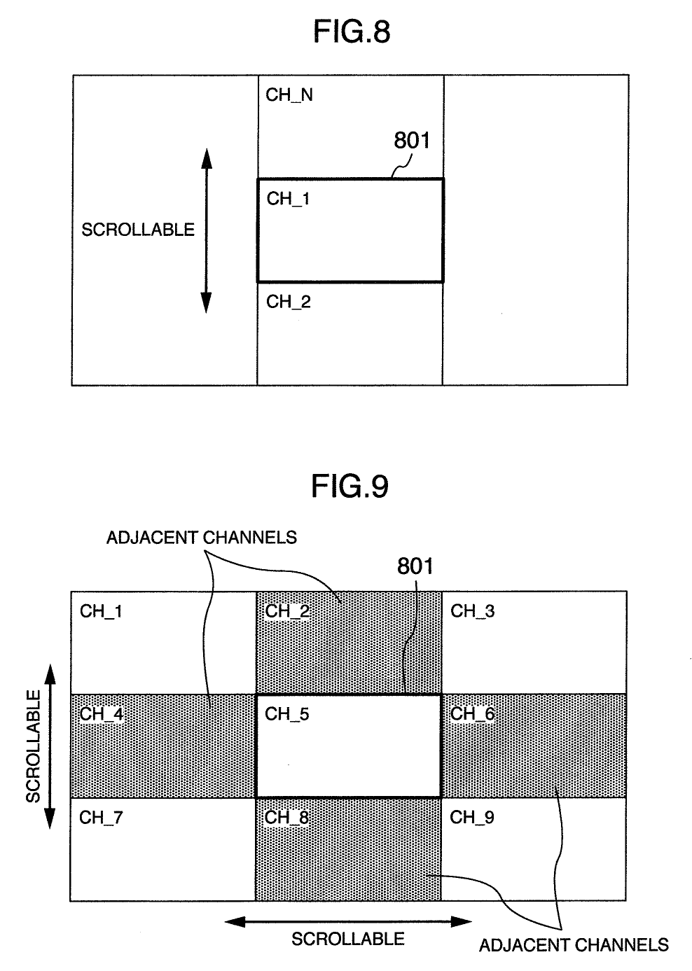

Next, a case to receive IP broadcast that is broadcasted via the network 105 is described. CPU 401 is connected to a main memory 402, and executes software, such as UI/application/browser described above, using programs, information, and the like stored in this main memory 402. Here, as the processing of UI which CPU 401 executes, a menu screen as shown in FIG. 8, for example, is displayed on the display 413. This menu screen displays channel information (number) corresponding to a plurality of contents, whereby a user can select one of them by the remote controller 404. If a user operates the remote controller 404 to move a cursor 801 and puts the cursor 801 on the display area of a desired channel of the menu screen for selection, this channel information is provided from the remote-controller input control section 403 to a network control section 407 via an I/F for control 414. In addition, although a screen of only three channels is displayed in the example of FIG. 8, the picture image of other channels can be displayed by scrolling the screen vertically. Moreover, this channel information may be not only the number but a still picture thumbnail of video, a moving picture thumbnail, a program title screen, EPG (electronic program guide), or ECG (electronic content table) indicative of the feature of a program. Moreover, it is also possible to accommodate the regular channel, dial, and jump button, or the like other than a scroll operation button equipped with the remote controller 404.

The network control section 407 is coupled with a network interface 408 that is connected to the home network 107 (or the network 105). Then, the network control section 407 transmits the channel information from the remote-controller input control section 403 to the network interface 408 as well as to the home gateway device 106 via the home network 107. The home gateway device 106 receives a stream of 100 channels of contents as described above, and extracts among them the content of a channel corresponding to the channel information transmitted from the network control section 407, and provides a stream thereof to the network control section 407 via the network interface 408 and home network 107. The network control section 407 receives the content that is delivered via the network interface 408, and takes out one-program information of partial content corresponding to the channel which a user desires to view.

A stream control section 409 determines whether a store request is being made or a view request is being made to the desired content. If a store request is being made, the partial content taken out in the network control section 407 is stored in HDD 410. On the other hand, if a view request is being made, the above-described partial content (PTS) is provided to the media processing/display control section 411, where a predetermined CODEC processing is carried out to the partial content in the work memory 412, and then this partial content is provided to the display 413. Moreover, it is preferable that the stream control section 409 determines whether or not the content obtained from the network control section 407 is encrypted and whether it is a pay content or not, and furthermore authentication by the security control section 405 is carried out, thereby allowing the content to be provides to a proper user and allowing the copyright protected content to be provided to an authorized user.

Moreover, the user action to the remote controller 404 may be compiled into a database by storing logs, such as an input history of the remote controller 404, into HDD 410. It is thus possible to carry out a service of automatically guiding the content which a user desires, the content including program information or the like on a channel which a user frequently views. Moreover, by using the above-described database, it is possible to selectively receive a plurality of same contents having different commercial messages (hereinafter, referred to as CM) inserted therein (namely, a content 1 having CM1 inserted therein and the content 1 having CM2 inserted therein) in the stream control section 409. This allows the information, which a user desires, to be provided more suitably. Moreover, a user can select CMs of a plurality of corporate sponsors in the same content at the identical time, which was not possible in the conventional broadcast service.

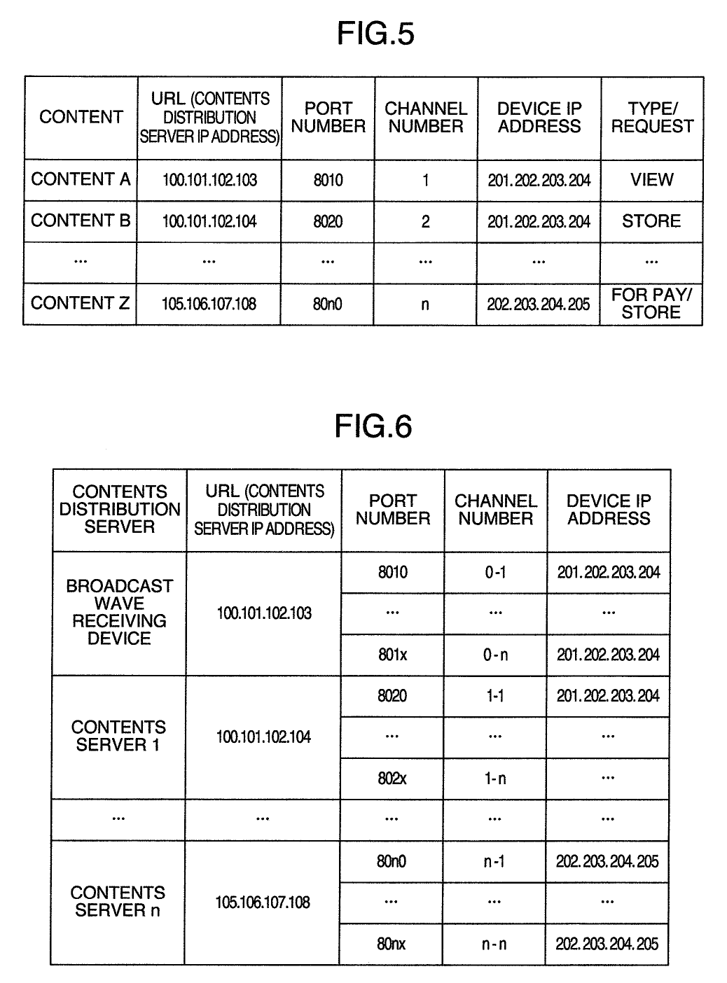

FIG. 5 shows an example of the database of user actions stored in HDD 410 of FIG. 4. This table holds, for each content, correspondence between content, URL (IP address) of a distribution server that delivers this content, a port number thereof, a channel number, a device IP address of an IP broadcast receiving terminal itself, and the types of request and content. Here, the types of request and content are for determining whether the content concerned is for pay or for free and also for determining whether a request from a user is a view request or a store request. By including this content reference table in the IP broadcast receiving terminal, it is possible to carry out a channel operation of a user and a reference processing of the table at high speed, thus allowing for an improvement in switching to a desired content and in the response performance of the remote controller 404.

In this table, the priority on the content or channel, which a user selects frequently, is made higher, for example, and the channel information (URL, port number, and the like of a distribution server) corresponding to a plurality of contents of high priorities (e.g., priorities ranging from 1 to 5) are transmitted from the network control section 407 to the home gateway device 106 in advance. If done this way, the home gateway device 106 can acquire a stream of contents of high priorities in advance based on the URL, port number, and the like of a distribution server, which are transmitted from the network control section 407. Accordingly, if configured this way, a stream of content which a user most likely desires can be acquired directly from the home gateway device 10, and there is therefore no need to access the contents distribution server each time channels are switched. As a result, the channel switching in IP broadcast can be carried out at higher speed.

Moreover, in the menu screen shown in FIG. 8, if a screen of Channel 2 exists adjacent to a screen of Channel 1 that is selected by a user, not only the channel information on Channel 1 but the channel information on the adjacent Channel 2 and Channel n may be transmitted from the network control section 407 to the home gateway device 106. In other words, this example utilizes a fact that the channel adjacent to a selected channel is most likely to be selected next, and such channel information, which is most likely to be selected, is transmitted to the home gateway device 106 in advance, thereby acquiring the desired content promptly. Of course, the number of channel information adjacent to a selected channel is not limited to two as in the above example but can be modified suitably according to the display form of the menu screen. For example, as shown in FIG. 9, a channel screen of 9 menu screens can be displayed, and if four adjacent channels adjacent to a selection channel (channel selected by the cursor 801) exist (e.g., Channels 2, 4, 6, and 8), all the channel information may be transmitted to the home gateway device 106. Also in the example of FIG. 9, as in FIG. 8, the information on other channels can be displayed by scrolling the screen vertically or horizontally under the instruction of a user.

FIG. 6 shows another example of the above-described database. This example causes each contents distribution server to have similar table functions hierarchically. This can reduce the hierarchical levels of content and accelerate switching to a desired content. Thus, according to this example, so many channels in broadband can be handled with the same operation feeling as that of the broadcast wave.

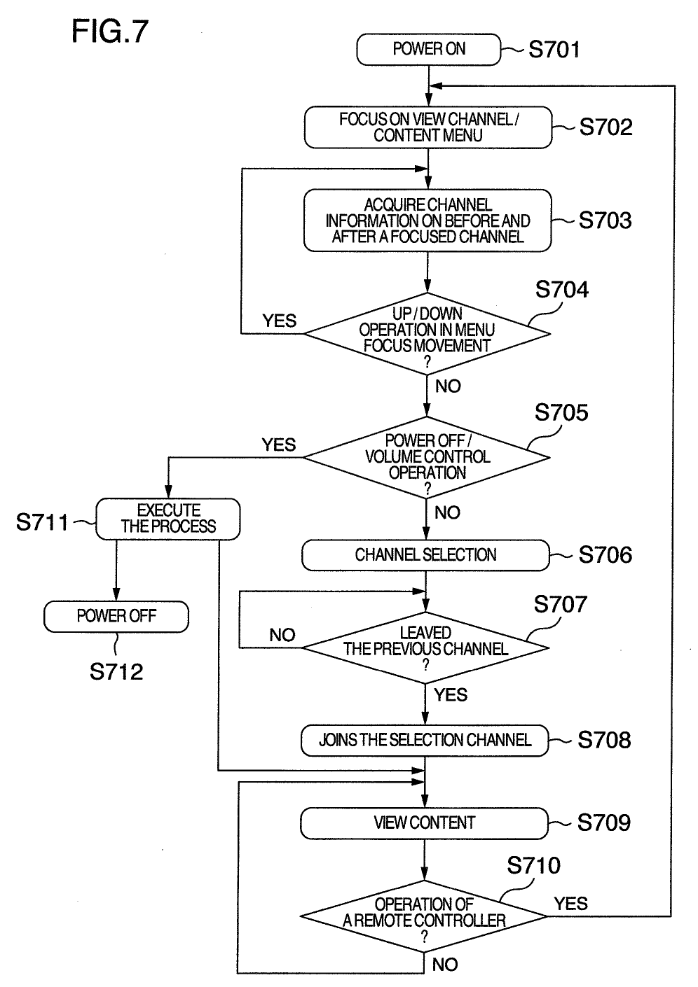

FIG. 7 shows a flowchart of the receive processing of IP broadcast concerning this embodiment. In addition, in the following description, each step is abbreviated as “S”. First, a power on processing (S701) is executed by the remote controller 404 to change to the menu screen. This menu screen is shown in FIG. 8 or FIG. 9 as described above. Next, a process (S702) to move the cursor to the screen of a desired channel/content which a user attempts to view is carried out by the remote controller 404. In addition, hereinafter, an action to set the cursor to a desired channel is referred to as “focus”. Then, information on a channel (namely, which can be easily focused by an UP/DOWN operation) adjacent to the focused channel is acquired (S703). Thus, the channel information, which is most likely to be selected next, can be acquired in advance, so that the user operation concerning switching of channels can be carried out comfortably. Then, in S704, it is determined whether the focus movement/UP/DOWN has been done or not, and if such operation has been done, the process of S703 and S704 will be repeated. This always updates the information on both before and after a focused channel.

On the other hand, if there is no menu operation in S704, then it is determined whether there is a power off operation or a volume control operation of sound other than the view/record operation (S705). If there is no such operation, a channel selection process (S706) is carried out and then a leave processing that disconnects a connection session with a distribution server, the leave processing being for switching from a previous channel which a user was viewing before, (hereinafter, referred to just as a leave processing) is carried out. Next, whether it has been caused to leave the previous channel or not is determined (S707), and if the leave processing has not completed, then the leave processing will be continued. On the other hand, if the leave processing has completed, channels are then switched by carrying out a join processing (S708) that establishes a connection session with a distribution server in response to a selection channel, (hereinafter, referred to as just a join processing). Thus, by preventing a user from joining the selection channel frequently, it is possible to realize stable channel switching, and by preventing the excessive issuing of connection sessions from the IP broadcast receiving terminal devices of a plurality of homes to the same distribution server, it is possible to reduce the load on the distribution server side, thereby allowing less expensive services to be provided.

This process is designed to be carried out within a few milliseconds, thereby avoiding a failure due to a careless operation by a user during the process and allowing for channel switching without losing high speed performance. The stream control section 409 stores only the join processing (S708) into HDD 410 as the data of a user action to thereby prepare the above-described database. Moreover, the network control section 407 determines that a channel selection has been made, and carries out view processing (S709) of the content via the network I/F 408 and displays the same on the display 413. Thus, viewing content using broadband, such as IP broadcast or VOD, is carried out. Moreover, it is determined whether there is an operation of the remote control or not (S710) and if the operation has occurred, it returns to the menu screen to repeat the above-described process. For the operations not related to viewing content, such as power off, CPU 401 carries out power off processing of the system (S712) and terminates such process. After executing the volume control operation of audio or the like (S711), the background process is carried out so as to continue viewing content. This increase convenience in the operation of channels without impairing operability. Moreover, also when powering on again after power off, it is possible to view from the program of a channel from the broadband which a user viewed immediately before because the channel information is stored in the same manner as in the current TV set.

This embodiment is utilized in content delivery services (IP broadcast, VOD, and content download) using a broadband network.

It should be further understood by those skilled in the art that although the foregoing description has been made on embodiments of the invention, the invention is not limited thereto and various changes and modifications may be made without departing from the spirit of the invention and the scope of the appended claims.

1. A receiving system for contents, comprising:
a home gateway device connected to an IP network and capable of receiving a stream, in which a plurality of contents are multiplexed, from the network; and
a receiving terminal connected to the home gateway device,
wherein the receiving terminal is capable of transmitting channel information corresponding to a desired content to the home gateway device, and
wherein the home gateway device extracts a content corresponding to the channel information from the receiving terminal among the multiplexed contents contained in the received stream, and supplies the extracted content to the receiving terminal.

2. The receiving system according to claim 1,
wherein the receiving terminal includes a database for holding correspondence between the content, an IP address or URL information of a distribution server that delivers the content, and channel information,
wherein the home gateway device receives the IP address stored in the database corresponding to a desired channel as the channel information from the receiving terminal, and
wherein the home gateway device accesses the distribution server using the received IP address and receives a stream in which the plurality of content are multiplexed.

3. The receiving system according to claim 2, wherein the database further holds a port number of the distribution server associated with the content.

4. The receiving system according to claim 2,
wherein the database stores request information together with the channel information, the request information being indicative of a view request or store request of the content, and
wherein the receiving terminal carries out an operation according to the stored request information corresponding to a desired channel.

5. The receiving system according to claim 1, wherein a plurality of the receiving terminals can be connected to the home gateway device via a home IP network.

6. The receiving system according to claim 2, wherein the receiving terminal transmits a plurality of channel information having high priority based on a view history among the channel information stored in the database, to the gateway.

7. The receiving system according to claim 1, wherein when view channels are switched, a connection state between the IP network and the distribution server is monitored.

8. A receiving device for contents, comprising:
an input section for inputting channel information; and
an IP network control section connectable to an external home gateway device and for transmitting the channel information inputted by the input section to the home gateway device,
wherein the IP network control section receives a stream of content corresponding to the channel information among a stream of multiplexed contents received in the home gateway device.

9. The receiving device according to claim 8, further comprising
a display section that displays video based on a stream of content received in the IP network control section,
wherein the display section can further display a menu screen including a plurality of items for selecting a desired content, and from this menu screen an item corresponding to the desired content is selected via the input section, and
wherein the IP network control section can transmit to the home gateway device the channel information of the content corresponding to the selected item and channel information of contents corresponding to items adjacent to the selected item.

10. A receiving device for contents, comprising:
a display section;
a menu generation section for generating a menu screen including a plurality of selectable channel information in the display section and for displaying the menu screen in the display section;
a remote controller for selecting a desired channel information on the menu screen displayed in the display section in response to an operation of a user; and
an IP network control section that transmits channel information selected from the menu screen in the remote controller, to an IP network to which the receiving device for contents is connected,
wherein the IP network control section transmits to the IP network the selected channel information and also the channel information displayed at positions adjacent to the selected channel information in the menu screen.

11. The receiving device according to claim 10, wherein a history of channel information selected by the user is stored therein.
